(19) United States
(12) Patent Application Publication
(10) Pub. No.: US 2022/0346331 A1
(43) Pub. Date: Nov. 3, 2022

(54) INTELLIGENT IRRIGATION MANAGEMENT SYSTEM

(71) Applicant: Tianjin KanTian Technology Co., Ltd., Tianjin (CN)

(72) Inventors: Simeng Yan, Fremont, CA (US); Wenxiu Sun, Redwood City, CA (US)

(21) Appl. No.: 17/243,542

(22) Filed: Apr. 28, 2021

(51) Int. Cl. A01G 25/16; G06F 16/245; G06F 16/28; G05B 13/02; A01G 25/02

(52) U.S. Cl. CPC A01G 25/167; G06F 16/245; G06F 16/284; G05B 13/028; A01G 25/02

(57) ABSTRACT

A system of one or more computers can be configured to perform particular operations or actions by virtue of having software, firmware, hardware, or a combination of them installed on the system that in operation causes or cause the system to perform the actions. One general aspect includes an intelligent irrigation system including one or more of a sprinkler and one or more processors configured to: obtain imagery data regarding a plant; determine a current life cycle stage of the plant based on the imagery data, determine a plant crop coefficient for the plant based on the current life cycle stage of the plant, determine irrigation water output for the plant based on the plant crop coefficient, potential evapotranspiration calculated using solar radiation, temperature, wind speed and/or any other factors, and control the sprinkler to irrigate the plant based on the irrigation water output determined for the plant.

### FIELD OF THE INVENTION

The invention generally relates to an intelligent irrigation system and a method therein.

### BACKGROUND OF THE INVENTION

Irrigation system is generally known. Irrigation is an artificial process of applying controlled amounts of water to land to assist in production of crops. Irrigation helps to grow agricultural crops, maintain landscapes, and revegetate disturbed soils in dry areas and during periods of less than average rainfall. Irrigation also has other uses in crop production, including frost protection, suppressing weed growth in grain fields and preventing soil consolidation.

Irrigation systems are also used for cooling livestock, dust suppression, disposal of sewage, and in mining. Irrigation is often studied together with drainage, which is the removal of surface and sub-surface water from a given location. Irrigation has been a central feature of agriculture for over 5,000 years and is the product of many cultures. Historically, it was the basis for economies and societies across the globe, from Asia to the Americas.

Traditional irrigation system typically requires human intervention and operation to control an amount of water output for the targets. This often involves human knowledge of weather, target (e.g., plants) growth condition, past experience and other factors. Modern irrigation system starts including a controller that can automatically control a frequency, an amount and other aspects of the irrigation system. For example, a user may set a number of times an irrigation system will operate during the day to supply water to an area covered by the irrigation system.

### SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an intelligent irrigation system including one or more of a sprinkler and one or more processors configured to: obtain imagery data regarding a plant; determine a current life cycle stage of the plant based on the imagery data, determine a plant crop coefficient for the plant based on the current life cycle stage of the plant, determine irrigation water output for the plant based on the plant crop coefficient, and control the sprinkler to irrigate the plant based on the irrigation water output determined for the plant. Other embodiments of this aspect include corresponding computer systems, apparatus, and computer programs recorded on one or more computer storage devices, each configured to perform the actions of the methods.

Implementations may include one or more of the following features. In some embodiments, the intelligent system may determine a plant parameter value including at least one of a type, a color, a height, or a size of the plant based on the imagery data regarding the plant; and determine the current life cycle stage of the plant based on the plant parameter value. In some embodiments, the intelligent system may search a database storing associations between different plant parameter values and corresponding different plants; and determine the current life cycle stage of the plant based on the associations and the plant parameter value of the plant. In some embodiments, the intelligent system may update the database based on at least one of a weather variable, user feedback information, or a geolocation variable. Implementations of the described techniques may include hardware, a method or process, or computer software on a computer-accessible medium.

Other objects and advantages of the invention will be apparent to those skilled in the art based on the following drawings and detailed description.

### BRIEF DESCRIPTION OF THE DRAWINGS

FIG. 1 illustrates an example of an overview of an intelligent irrigation system.

FIG. 2 illustrates an example of a server in the intelligent irrigation system.

FIG. 3 shows an example of a plant image recognition module for determining plant feature parameters and a plant life cycle stage determination module for determining plant current life cycle stage.

FIG. 4 illustrates an example of a plant life cycle database.

FIG. 5 illustrates an example of update of a plant life cycle database.

FIG. 6 illustrates an example of an irrigation coefficient determination sub-module, an ETo determination sub-module, and an irrigation algorithm for determining an irrigation output.

FIG. 7 illustrates an example of a plant crop coefficient database 604.

FIG. 8 illustrates an example of update of a plant crop coefficient database.

FIG. 9 illustrates an example method for controlling an intelligent irrigation system.

FIG. 10 illustrates an example of a simplified computer system for implementing various embodiments described and illustrated herein.

### DETAILED DESCRIPTION

Irrigation management system is a type of management system designed to control timing and amount of irrigation water in a way that satisfies water requirements for a crop without wasting water and degrading soil resources. The irrigation management system applies water according to specific crop needs in amounts that can be held in the soil and at rates consistent with intake characteristics of the soil.

As irrigation management systems have become more wide-spread, determining an efficient irrigation scheduling scheme has garnered some attention. The challenge is to determine when to irrigate and how much water to apply in order to prevent excessive use of irrigation water and improve crop growth efficacy. If irrigation frequency is too high and irrigation water amount is too large, the amount of irrigation water provided by the irrigation management systems will be more than what is needed for crop growth, resulting in excessive use of irrigation water. If irrigation frequency is too low and irrigation water amount is too small, on the other hand, the amount of irrigation water provided by the irrigation management systems will not be enough to support crop growth, resulting in poor crop quality.

In various embodiments, irrigation management systems in accordance with the present disclosure may be used to provide information such that irrigation decision makers can use to develop irrigation strategies. Such strategies may be made based on information about type of crop, soil condition, weather data, and management objectives to tailor irrigation scheduling procedures to a specific irrigation decision maker.

However, many water irrigation scheduling solutions provided by some existing irrigation management system are not accurate or complete when considering the fact that a crop has different plant life cycle stages, whereas each plant life cycle stage may need different amount of irrigation water to fulfill its growth needs. For example, those systems typically do not take plant life cycle stages into considerations when determining water irrigation amounts. Moreover, those systems typically lack a mechanism to take into account real-time user feedback to adjust water irrigation amounts. As an example, plant life cycle stages for a particular plant may change based on different geolocations of the plant, different garden conditions for the plant, weather information for plant growth and/or any other aspects regarding plant growth environment. Such changes in plant life cycle stages may be used for adjusting water irrigation amounts.

Besides plant life cycle stages, other considerations for determining water irrigation amounts may include determining and/or adjusting an irrigation amount based on an irrigation coefficient, weather data, automatic learning adjustments, user feedbacks, and/or any other considerations for determining water irrigation amounts. When determined optimally, the water irrigation amounts can prevent excessive use of irrigation water and improve crop growth efficacy.

One motivation behind the present disclosure is to determine water irrigation output amounts based on a current plant life cycle stage for a particular plant of interest. Inventor(s) of the present disclosure had an insight that plant growth conditions may be monitored and determined when determining an irrigation amount. At a high level, in accordance with the present disclosure, information regarding plant growth conditions are considered when the irrigation amount is determined by an irrigation management system. Traditionally, plant growth conditions are not monitored and/or determined by an irrigation management system. Typically, in such a traditional system, plant growth would either be ignored or input by a human operator when determining the irrigation amount. As mentioned above, in the traditional system, the determined irrigation amount may not be accurate and complete, leading to either over-watering or under-watering. In a case where a human operator provides plant growth information when determining the irrigation amount (for example, the human operator may adjust the irrigation amount based on his/her observation of the plant growth), this can be inefficient and not optimal. For instance, such an approach may not scale well in a situation where many crops/fields are irrigated and they have different plant growth conditions. A human operator may attend one field and adjust irrigation amount for that field, but it would be tedious for the human operator having to attend many fields through this approach.

In various embodiments, for facilitating above-mentioned plant growth monitoring and determining when determining an irrigation amount, information regarding a current plant life cycle stage for the particular plant may be gathered, for example, through imagery data about the plant. From the imagery data, in those embodiments, one or more features of the particular plant can be recognized, for example, using an image recognition program. These features can then be used to determine the current plant life cycle stage for the particular plant, for example, automatically. In those embodiments, the determined current plant life cycle stage for the particular plant can be fed into a water irrigation determination algorithm for determining water irrigation output amounts for the particular plant. In some embodiments, user feedback information, geolocations and/or area information regarding the particular plant, and/or any other suitable information may be obtained and processed. The water irrigation determination algorithm can also be configured to take such information into account when determining the water irrigation out amounts. Thus, various embodiments in accordance with the present disclosure can improve irrigation management system, irrigation system and/or any other like technical fields.

### EXAMPLE SYSTEM

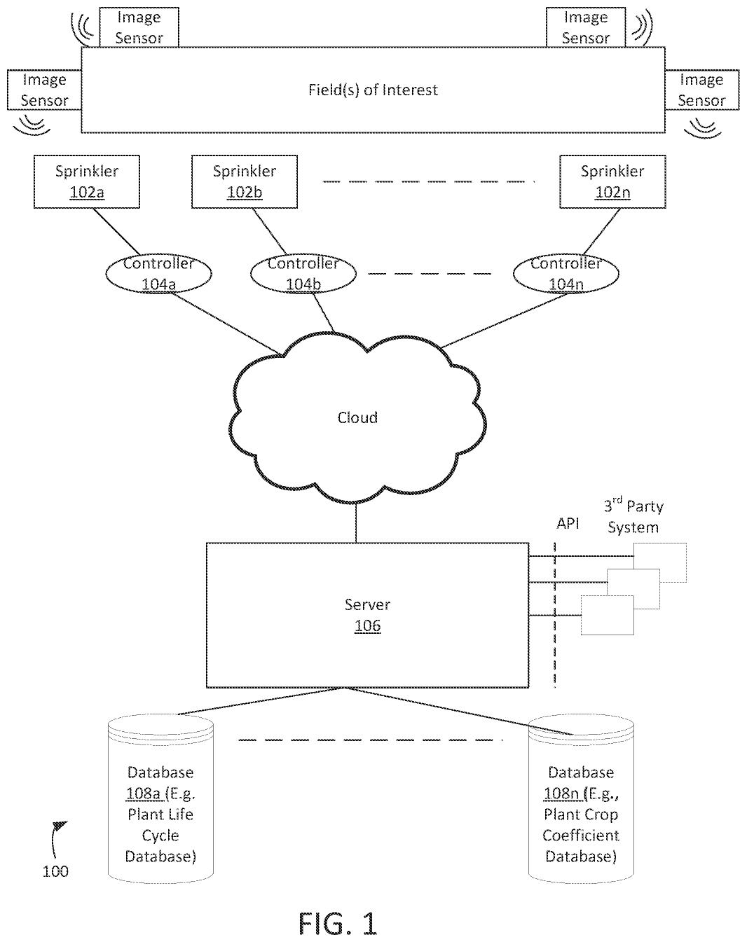

FIG. 1 illustrates an example of an overview of an intelligent irrigation management system 100 in accordance with the present disclosure. As shown, the intelligent irrigation management system 100 may include a server 106, one or more controllers such as controllers 104a, b and n shown, one or more sprinklers such as 102a, b, and n shown, one or more image sensors, one or more databases such as database 108a, b, n shown, and/or any other components. The one or more image sensors can be configured to capture imagery data of one or more plants located in one or more fields of interest as shown. In some implementations, the image sensors are cameras positioned in or towards the field(s) of interest as shown. The imagery data captured by the one or more image sensors contains imagery information regarding the plants such as plant type, color, height, shape, size, and/or any other aspects regarding the plants. Example imagery data captured by the image sensors may include still images, videos, and/or any other types of imagery data.

In this example, the intelligent irrigation management system 100 includes the server 106, which may be configured to receive and/or obtain the imagery data captured by the image sensors. In some embodiments, the server 106 may be configured to receive and/or obtain the imagery data directly from the image sensors. In some other embodiments, the server 106 may be configured to receive and/or obtain the imagery data from the controller 104 which may be configured to receive and/or obtain the imagery data from the image sensors. In some other embodiments, the server 106 may be configured to receive and/or obtain the imagery data from a third party database which may contain imagery data of the plants.

The server 106 may be configured with a computer program to recognize the imagery information regarding the plants from the imagery data captured by the image sensors. Based on the imagery information recognized by the server 106, the server 106 may be configured to determine a current life cycle stage of the plants. A current life cycle stage of a given plan may be referred to a particular period corresponding to a growth of the given plant at the time of the imagery data. Examples of the current life cycle stage of the given plant may include an initial stage, a crop development stage, a mid-season stage, a late-season stage, and/or any other life cycle stages for a plant.

In this example, the sever 106 may be configured to determine an irrigation output based on the determined current life cycle stage of the plants, an irrigation coefficient of the plants, an evapotranspiration parameter of the plants, geolocation data of the plants, agricultural data of the plants, weather data, and/or any other types of data.

In this example, the server 106 is operatively connectable to one or more 3^{rd} party systems via application program interfaces. The 3^{rd} party system(s) may include a weather service system providing weather information to the server 106; may include a system providing agricultural data such plant life cycle data regarding various plants trackable by the server 106; may include imagery data such as satellite image data regarding the field(s) of interest; and/or any other 3^{rd} party system.

In this example, the server 106 is operatively connected to the controllers 104a-n via a cloud as shown. The controllers 104a-n may be configured to receive and/or obtain the irrigation output as determined by the server 106. An individual controller, such as the controller 104a, can be configured to control a corresponding sprinkler. The individual controller can be configured to control one or more than one sprinkler. In one implementation, the individual controller is a console deployed at a site near the field(s) of interest. For instance, the individual controller, such as the controller 104a, is installed in a controller room next to the field(s) of interest to control the sprinklers.

In this example, the server 106 is operatively connected to one or more databases 108a-n, which may include a plant life cycle database, a plant irrigation coefficient database, and/or any other database. The server 106 in this example is configured to read data from databases 108a-n, update databases 108a-n, and/or perform any other operation related to databases 108a-n.

### Application Examples of Server

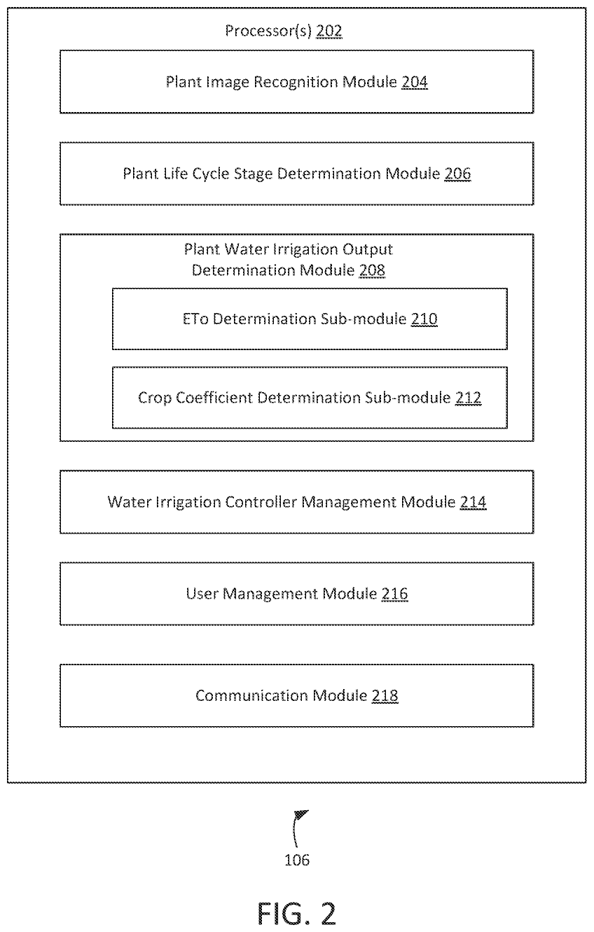

FIG. 2 illustrates one example for the server 106 shown in FIG. 1. As shown, the example server 106 shown in FIG. 2 may include one or more of a processor 202 configured to execute one or more computer program components including a plant image recognition module 204, a plant life cycle stage determination module 206, a plant water irrigation output determination module 208, a water irrigation controller management module 214, a user management module 216, a communication module 218, and/or any other components. The plant water irrigation output determination module 208 may include an ETo determination sub-module 210, a crop coefficient determination sub-module 212, and/or any other components.

In this example, the plant image recognition module 204 can be configured to recognize certain features regarding the plants from the imagery data captured by the image sensors. Example features recognized by the plant image recognition module 204 may include the type, color, height, shape, size and/or any other features regarding the plants.

Based on the features recognized by the plant image recognition module 204, the plant life cycle stage determination module 206 may be configured to determine the current life cycle stage of the plants defined previously. Based on the determined current life cycle stage, the plant water irrigation output determination module 208 can be configured to include an irrigation algorithm to determine an irrigation output.

In one implementation, the water irrigation controller management module 214 may be configured to control the sprinkler(s) 102 based on the irrigation output. In this implementation, the water irrigation controller management module 214 can be operatively connected to the controllers 104a-n which can be configured to control one or more than one sprinkler.

In some embodiments, the user management module 216 may be configured to provide feedback from users for fine-tuning the plant image recognition module 204, the plant life cycle stage determination module 206, the plant water irrigation output determination module 208, the water irrigation controller management module 214, and/or any other modules. The feedback from the users may be referred to information such as plant types, plant features, geolocation data, weather data, and/or any other data. In one implementation, the user management module 216 may be a console configured to include a user interface to provide feedback from the users.

The communication module 218 may be configured to include one or more communication channels connecting two or more modules in the server 106. A communication channel may be referred to a transmission medium used to convey an information signal from one or more transmitters to one or more receivers. Examples of communication channels may include communication channel between the plant image recognition module 204 and the plant life cycle stage determination module 206, communication channel between the plant water irrigation output determination module 208 and the water irrigation controller management module 214, the water irrigation controller management module 214 and individual sprinklers, the user management module and individual users and/or any other communication channels connecting two or more modules in the server 106.

### Application Examples of Plant Image Recognition Module and Plant Life Cycle Stage Determination Module

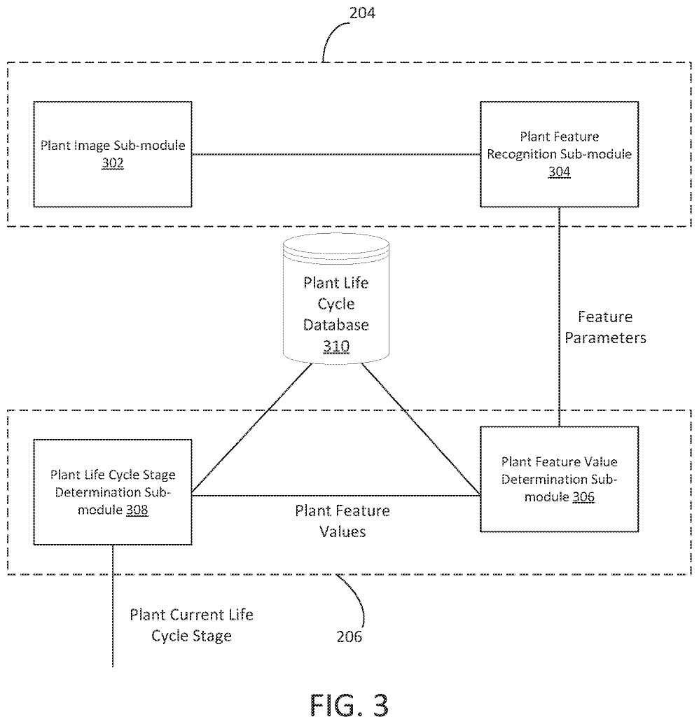

FIG. 3 illustrates one example of the plant image recognition module 204 for recognizing the plant features and the plant life cycle stage determination module 206 for determining the plant current life cycle stage shown in FIG. 2. As shown, the plant image recognition module 204 may include a plant image sub-module 302, a plant feature recognition sub-module 304, and/or any other components. The plant image sub-module 302 may be configured to receive and/or obtain the imagery data captured by the image sensors. In some embodiments, the plant image sub-module 302 may be configured to receive and/or obtain the imagery data directly from the image sensors. In some other embodiments, the plant image sub-module 302 may be configured to receive and/or obtain the imagery data from the controller 104 which may be configured to receive and/or obtain the imagery data directly from the image sensors. In some other embodiments, the plant image sub-module 302 may be configured to receive and/or obtain the imagery data from a third party database which may contain imagery data of the plants.

In one implementation, the image sensors may be configured to capture the imagery data in a format such as an array: X={x₁, x₂, . . . , x_{W×H}}, where W denotes the width of the image, H denotes that height of the image, and xᵢ denotes the intensity of the image at the i-th pixel location which may include one or more components.

Based on the imagery data received and/or obtained from the plant image sub-module 302, the plant feature recognition sub-module 304 may be configured to identify one or more feature parameters of the plant from the imagery data. The feature parameters of the plants may be referred to imagery information regarding the plants. Example feature parameters identified from the imagery data may include type, color, height, shape, size and/or any other features regarding the plants.

In this example, the plant feature value determination sub-module 306 may be configured to determine plant feature values for the feature parameters identified by the plant feature recognition sub-module 304 based on the imagery data received and/or obtained by the plant image sub-module 302. In one implementation, the plant feature value determination sub-module 306 may be configured to determine the plant feature values in a format such as an array: Y={y₁, y₂, . . . , Yₘ}, where yᵢ denotes the plant feature value of i-th feature parameter which may include one or more components and m denotes the number of feature parameters identified by the plant feature recognition sub-module 304. It should be understood that feature values determined by the plant feature value determination sub-module 306 does not have to be a value specifically identifying a feature of a plant of interest. For example, a set of characteristic values may be obtained by the plant feature value determination sub-module 306 based on a color and a size of the plant. An individual characteristic value in the set does not have to identify—for example the color of the plant. In that example, the characteristic values may be used to distinguish plant growth conditions using a combination of color and size. Other examples are contemplated.

The plant life cycle stage determination sub-module 308 may be configured to determine a current life cycle stage of the plants based on the plant feature values determined by the plant feature value determination sub-module 306, a plant life cycle database 310, and/or any other components. As defined herein, a current life cycle stage of a given plan may be referred to a particular period corresponding to a growth of the given plant at the time of the imagery data. Examples of the current life cycle stage of the given plant may include an initial stage, a crop development stage, a mid-season stage, a late-season stage, and/or any other life cycle stages for a plant. At a high level, the current life cycle stage of the given plant can be determined based on the plant feature values determined by the plant feature value determination sub-module 306. For example, if a color and size is determined for the given plant by the plant feature value determination sub-module 306, a current plant life cycle stage can be automatically determined based on such. This may involve a mapping translation from the feature(s) determined by the plant feature value determination sub-module 306 to a corresponding current plant life cycle stage using a plant life cycle database 310.

The plant life cycle database 310 may be referred to an organized collection of data comprising life cycle stages of the plants. TABLE 1 illustrates an example of the plant life cycle database 310. In this embodiment shown in FIG. 3, plant life cycle database 310 is an example database, such as the database 108a, connectable to a server 106 comprising a processor, such as processor 202 shown FIG. 2, having various modules shown in FIG. 3. In implementation, the plant life cycle database 310 may comprise a table such as the TABLE 1 shown below. By way of non-limiting example, a first column in TABLE 1 may show types of crops in the plant life cycle database 310. The second to fifth columns in TABLE 1 show the number of days in an initial stage, a crop development stage, a mid-season stage, a late-season stage of the plants. The sixth column in TABLE 1 shows the total number of days in all current life cycle stages of the plants. In various implementations, such a database may be first established by incorporating existing agricultural data from a published source, user input, and/or any other sources. As will be illustrated below, such a database may be updated automatically based on weather, user, geolocation data and/or any other data during a life time of an irrigation management system in accordance with the disclosure.

As shown in TABLE 1, an individual type of plant can be associated with a value identifying a particular time period measured by days for a corresponding plant life cycle stage. For example, the value 31 identifies tomato is in the initial growth stage when the tomato is grown between 0 to 31 days, in the development stage when the tomato is grown between 32 to 72 days, in the middle stage when grown between 74 to 125 days, and in the late stage when grown between 126 to 154 days. In various examples, a particular plant life cycle corresponding to a current growth may be obtained based on different factors, for example (using tomato as an illustration) a shade of color of the tomato as indicated by the image data of the tomato . In that example, if shade of color of the tomato has a feature value as determined by the plant feature value determination sub-module 306 corresponding to a number of days for a growth of the tomato, it can be determined that the tomato is in a corresponding life cycle based on the number of days determined.

TABLE 1
Example of the plant life cycle database 310

| Crop | Init. | Dev. | Mid. | Late | Total |
|---|---|---|---|---|---|
| Tomato | 31 | 41 | 53 | 29 | 154 |
| Cucumber | 23 | 33 | 45 | 18 | 119 |
| Sweet peppers | 29 | 38 | 75 | 25 | 167 |
| Beans-green | 18 | 28 | 28 | 10 | 84 |
| Carrots | 27 | 40 | 63 | 23 | 153 |
| Squash, Zucchini | 23 | 33 | 25 | 15 | 96 |
| Onion | 18 | 30 | 90 | 43 | 181 |
| Lettuce | 28 | 39 | 29 | 10 | 106 |
| Peas | 23 | 27 | 33 | 17 | 100 |
| Citrus | 60 | 90 | 120 | 95 | 365 |
| Olives | 30 | 90 | 60 | 90 | 270 |
| Pistachios | 20 | 60 | 30 | 40 | 150 |

### Application Examples of Plant Life Cycle Database

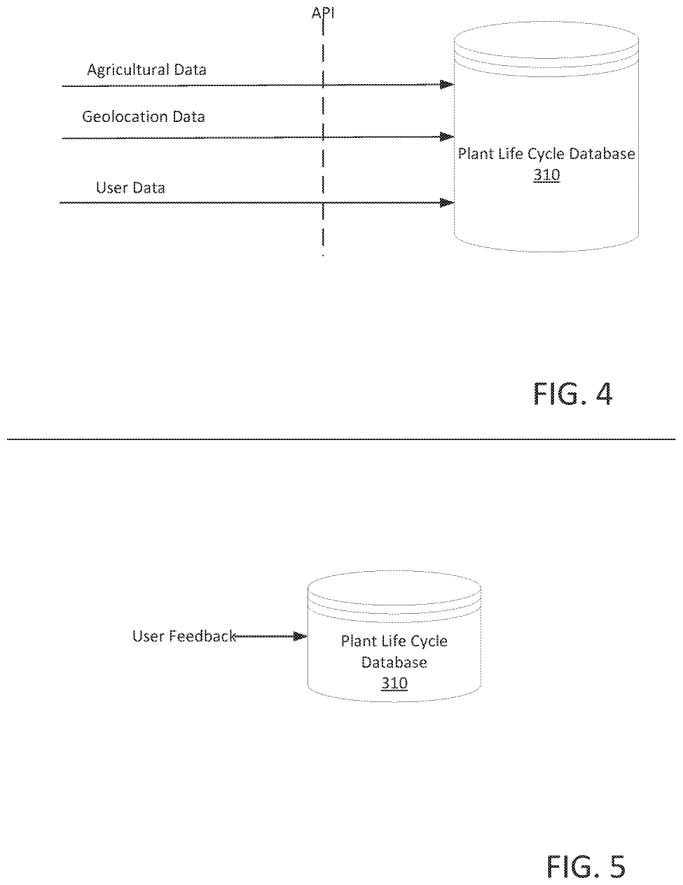

FIG. 4 shows an example of the plant life cycle database 310 in accordance with the disclosure. As shown, the plant life cycle database 310 may be configured to receive and/or obtain agricultural data, geolocation data, user data, and/or any other types of data from various sources including the 3rd party system(s) shown in FIG. 1. Agricultural data may be referred to data related to growth conditions of the given plants. Examples of the agricultural data may include plant types, number of days in plant life cycle stages, and/or any other data related to growth conditions of the given plants. Geolocation data may be referred to data related to geographical location of the plants. Examples of the geolocation data may include latitude, longitude, and/or any other types of data related to geographical location of the plants. User data may be referred to qualitative and/or quantitative data provided by users of the intelligent irrigation management system 100. Examples of the user data may include new plant types, new features of the plants, new life cycle stages of the plants, and/or any other user data. Such data may be used to set up the plant life cycle database 310 in accordance with the present disclosure.

In various embodiments, the plant life cycle database 310 may comprise an agricultural data table indicating agricultural data regarding one or more plants such as TABLE 1 shown above; a geolocation data table indicating geolocations of different plants tracked by plant life cycle database 310; a user data table indicating user feedback information regarding the plants. In those embodiments, based on the imagery data of a particular plant, the plant life cycle stage determination sub-module 308 may be configured to determine an agriculture score, a geolocation score, and a user score for the particular plant. The plant life cycle stage determination sub-module 308 in those embodiments are configured to determine an overall score to indicate a growth progress for the particular plant based on such scores. For example, based on an image of the tomato, the plant life cycle stage determination sub-module 308 may determine an agriculture score of the tomato based on, for example, various features of the tomato as described herein. The plant life cycle stage determination sub-module 308 may determine a geolocation score for the tomato based on a geolocation of the tomato for example as indicated by the image data. The plant life cycle stage determination sub-module 308 may be configured to adjust the agriculture score using the geolocation score. Similarly, the plant life cycle stage determination sub-module 308 may determine a user score based on user provided information regarding the tomato, and adjust the agriculture score of the tomato using the user score. Other implementations are contemplated.

FIG. 5 shows an example for fine tuning or updating the plant life cycle database 310 in accordance with the present disclosure. As shown, the plant life cycle database 310 may be updated based on user feedback information regarding plant life cycle stages for the plants tracked by the plant life cycle database 310. The user feedback information may include user adjustment to the plant life cycle stage corresponding to a particular plant. For example, the user feedback may indicate that tomatoes for this user at a particular geolocation of the user's fields have an initial growth stage of 35 days (different from the agriculture data shown above in TABLE 1). Based on this user feedback information, the plant life cycle database 310 can be updated to reflect such.

Algorithm 1 illustrates an example of pseudocode of the plant life cycle database 310 update

```
Algorithm 1 Example of pseudo code of
the plant life cycle stay database update.
INPUT Current_life_cycle, User_life_cycle
DEFINE threshold_param
FUNCTION Life_cycle_eval
  Pass In: Current_life_cycle, User_life_cycle
  Compare Current_life_cycle and User_life_cycle
  Pass Out: Life_cycle_eval_output
ENDFUNCTION
IF Life_cycle_eval_output >= threshold_param
  Life_cycle_update_request = 1
ELSE
  Life_cycle_update_request = 0
OUTPUT Life_cycle_update_request
```

### Determining Water Irritation Output

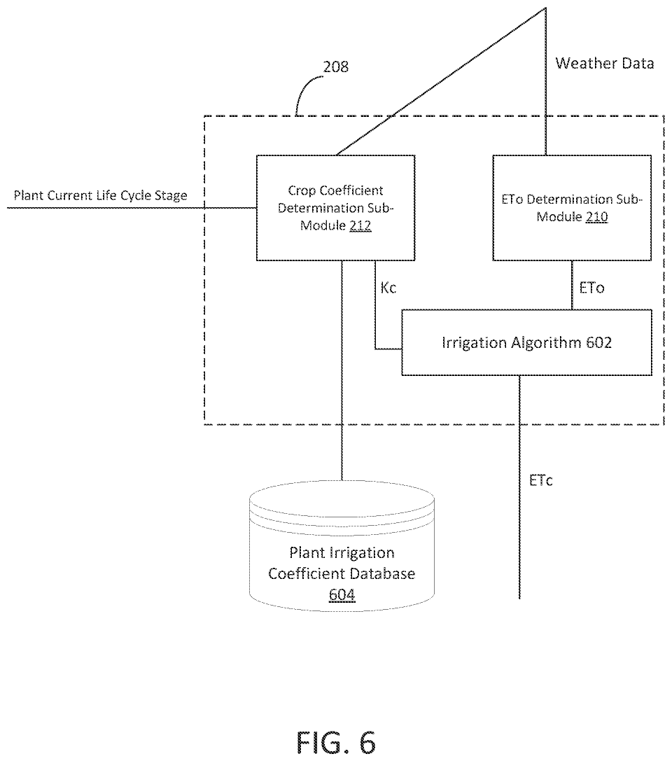

With determining the current plant life cycle stage having been described, attention is now directed to FIG. 6, which illustrates one example of the plant water irrigation output determination module 208 shown in FIG. 2. As shown, the plant water irrigation output determination module 208 may include an ETo determination sub-module 210, a crop coefficient determination sub-module 212, an irrigation algorithm 602, and/or any other components.

In this example, the ETo determination sub-module 210 may be configured to receive and/or obtain weather data. Examples of the weather data may include temperature, humidity, barometric pressure, precipitation, real-time solar radiation, wind speed, wind direction, and/or any other weather data. Based on the weather data and/or any other data, the ETo determination sub-module 210 may include a computer program configured to determine an evapotranspiration parameter ETo. An evapotranspiration parameter ETo may be referred to a reference evapotranspiration value defined as a rate at which readily available soil water is vaporized from specified vegetated surfaces. The evapotranspiration parameter ETo may be determined by a set of weather data including temperature, humidity, barometric pressure, precipitation, real-time solar radiation, wind speed, wind direction, and/or any other weather data.

The crop coefficient determination sub-module 212 may be configured to receive and/or obtain the plant current life cycle stage from the plant life cycle stage determination module 206, the weather data, and/or any other data. The crop coefficient determination sub-module 212 may include a computer program configured to determine a crop co efficient Kc for the plants based on the plant current life cycle stage, the weather data, and/or any other data. An insight provided by the inventor(s) of the present disclosure is that the crop coefficient should be computed when determining the irrigation amount based on the plant current life cycle stage. Traditional irrigation systems typically either ignore this value or fix it to a predetermined number. As explained above, the traditional approach essentially does not take into account a growth condition of the plant. For example, the traditional approach may determine tomatoes in the initial stage should receive the same amount of irrigation water as the ones in the late stage. This is because the traditional approach determines the irrigation amount mainly based on weather and/or user input, while ignoring the fact that different plant life cycle stages often correspond to different irrigation amounts for growth efficacy. Thus, the determination Kc based on the determined current life cycle stage for the plant, in accordance with disclosure, is configured into irrigation amount determination algorithm to produce a more accurate and efficient irrigation amount compared with the traditional systems.

As used herein, the crop coefficient Kc may be referred to a factor of the plants used in calculating irrigation water of the plants. In some embodiments, the crop coefficient determination sub-module 212 may be connected to a plant crop coefficient database 604. A plant crop coefficient database 604 may be referred to an organized collection of data comprising the plant types, the crop coefficient Kc at various stages of the plant, and/or any other data. TABLE 2 illustrates an example of the plant crop coefficient database 604. In this example, the first column in TABLE 2 shows types of crops in the plant crop coefficient database 604. The second to fourth columns in TABLE 2 show values of Kc in an initial stage, a mid-season stage, and an end-season stage of the plants. As can be seen, once a current life cycle stage of the plant is determined, a corresponding Kc can be determined using such a database. For example, when tomatoes are determined to be in the initial stage, a Kc of 0.6 can be determined. As can be seen, different current life cycle stages of the plants can have different Kc.

TABLE 2
Example of the plant crop coefficient database 604

| Crop | Kc ini | Kc mid | Kc end |
|---|---|---|---|
| Tomato | 0.6 | 1.15 | 0.8 |
| Cucumber | 0.55 | 1 | 0.825 |
| Sweet Peppers (bell) | 0.6 | 1.05 | 0.9 |
| Beans-green | 0.5 | 1.05 | 0.9 |
| Carrots | 0.7 | 1.05 | 0.95 |
| Squash, Zucchini | 0.5 | 0.95 | 0.75 |
| Onions | 0.7 | 1.05 | 0.75 |
| Lettuce | 0.7 | 1 | 0.95 |
| Peas | 0.5 | 1.15 | 1.1 |
| Citrus | 0.71 | 0.68 | 0.72 |
| Olives | 0.65 | 0.7 | 0.7 |
| Pistachios | 0.4 | 1.1 | 0.45 |
| Walnut Orchard | 0.5 | 1.1 | 0.65 |
| Peach | 0.58 | 1.03 | 0.76 |
| Apple | 0.59 | 1.08 | 0.81 |
| Grape | 0.3 | 0.77 | 0.45 |
| Banana | 0.5 | 1.1 | 1 |
| Cherry | 0.59 | 1.08 | 0.81 |
| Olives | 0.65 | 0.7 | 0.7 |

In one implementation, the irrigation algorithm 602 may be configured to determine an irrigation output ETc based on the crop coefficient Kc, the evapotranspiration parameter ETo, and/or any other parameters. An irrigation output ETc may be referred to as an amount of full potential water use by the plant. Algorithm One example irrigation amount can be Etc=ETo×Kc. It should be understood this is not intended to be limiting. Other examples of Etc calculation based on Kc are contemplated. For example, it is contemplated that Kc may be used as a weight added to weight the irrigation amount according to the current life cycle stage of the plant. Algorithm 2 illustrates an example of pseudocode of the irrigation algorithm 602.

```
Algorithm 2 Example of pseudo code of the irription algorithm 602.
INPUT Kc, ETo
FUNCTION Irrigation_compute
  Pass In: Kc, ETo
  Compute Etc from Kc, ETo
  Pass Out: ETc
ENDFUNCTION
ETc = Irrigation_compute (ETo, Kc, Weather_var)
OUTPUT ETc
```

### Application Examples of Plant Crop coefficient Database

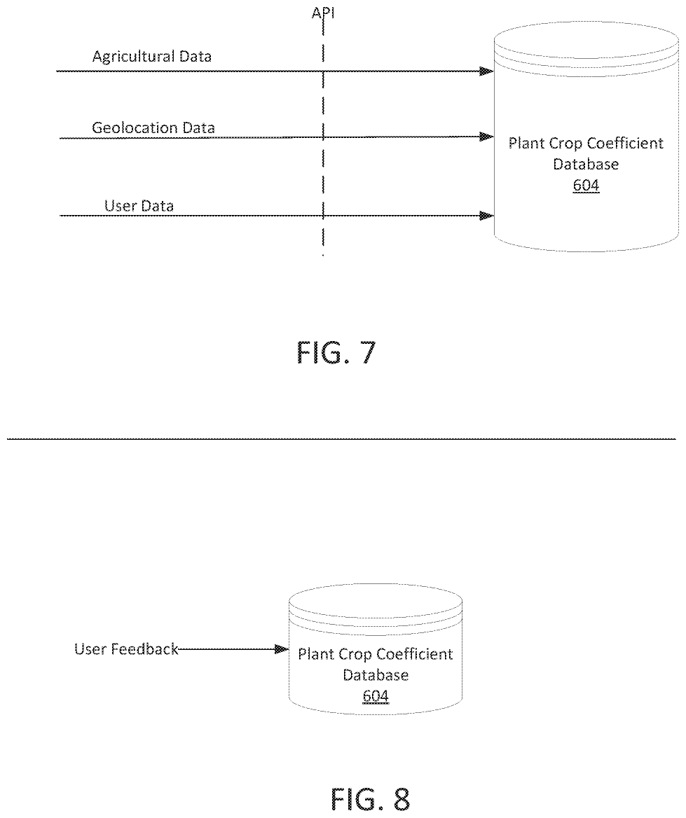

FIG. 7 shows an example of the plant crop coefficient database 604. As shown, the plant crop coefficient database 604 may be first established through published agricultural data, geolocation data of the plants, user data, and/or any other types of data gather from various sources including the 3^{rd} party system(s) shown in FIG. 1

FIG. 8 shows an example for fine tuning or updating the plant crop coefficient database 604 in accordance with the present disclosure. As shown, the plant crop coefficient database 604 may be updated based on user feedback information regarding plant crop coefficients for the plants tracked by the plant crop coefficient database 604. The use feedback information may include user adjustment to the plant crop coefficient corresponding to a particular plant. For example, the user feedback may indicate that tomatoes for this user at a particular geolocation of the user's fields have a Kc of 0.62 (different from the agriculture data shown above in TABLE 2). Based on this user feedback information, plant crop coefficient database 604 can be updated to reflect such.

Algorithm 3 illustrates an example of pseudocode of the plant crop coefficient evaluation updating in accordance with the disclosure.

```
Algorithm 3 Example of pseudo code of the
irrigation coefficient evaluation module 606.
INPUT Kc, User_Kc
DEFINE threshold_param_Kc
FUNCTION Kc_eval
  Pass In: Kc, User_Kc
  Compare Kc and User_Kc
  Pass Out: Kc_eval_output
ENDFUNCTION
IF Kc_eval_output >= threshold_param_Kc
  Kc_update_request = 1
ELSE
  Kc_update_request = 0
OUTPUT Kc_update_request
```

### Controlling Individual Sprinklers

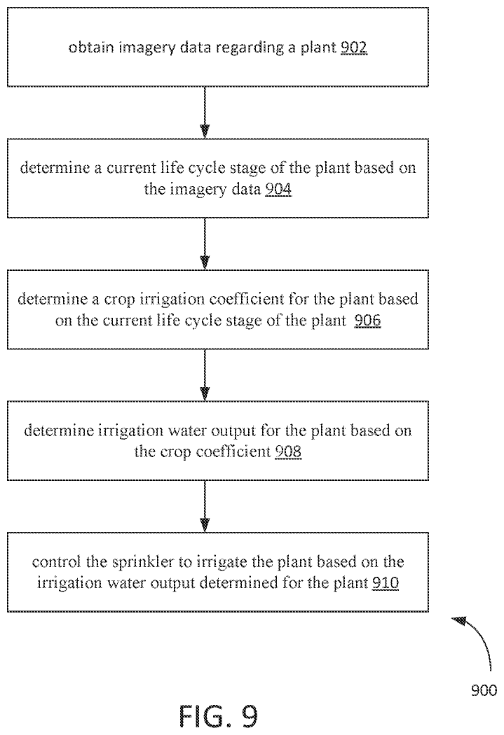

FIG. 9 illustrates another example of an application scenario of the intelligent irrigation management system 100. The operations of method 900 presented below are intended to be illustrative. In some embodiments, method 900 may be accomplished with one or more additional operations not described and/or without one or more of the operations discussed. Additionally, the order in which the operations of method 900 are illustrated in FIG. 9 and described below is not intended to be limiting.

In some embodiments, method 900 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

At an operation 902, the imagery data regarding a plant can be obtained. In some embodiments, the imagery data may be obtained directly from the image sensors. In some other embodiments, the imagery data may be obtained from controller(s) which may be configured to receive and/or obtain the imagery data directly from the image sensors. In some other embodiments, the imagery data may be obtained from a third party database. Based on the imagery data, certain features of the plants can be recognized. Example features recognized from the imagery data may include the type, color, height, shape, size and/or any other features regarding the plants.

At an operation 904, a current life cycle stage of the plant can be determined based on the features recognized from the imagery data at 902, an organized collection of data comprising life cycle stages of the plants, and/or any other components. As defined previously, a current life cycle stage of a given plan may be referred to a particular period corresponding to a growth of the given plant at the time of the imagery data. The organized collection of data comprising life cycle stages of the plants may be updated based on agricultural data, geolocation data, user data, and/or any other types of data. Please refer to FIG. 3-5 for more details of 904.

At an operation 906, a water irrigation coefficient for the plant may be determined based on the current life cycle stage of the plant determined at 904, an organized collection of data comprising crop coefficient of the plants, weather data, and/or any other data. The organized collection of data comprising crop coefficient of the plants may be updated based on agricultural data, geolocation data, user data, and/or any other types of data. Please refer to FIG. 6-8 for more details of 906.

At an operation 908, an irrigation output may be determined based on the water irrigation coefficient determined at 906, an evapotranspiration parameter, and/or any other parameters. The evapotranspiration parameter may be determined by a set of weather data including temperature, humidity, barometric pressure, precipitation, real-time solar radiation, wind speed, wind direction, and/or any other weather data. Please refer to FIG. 6 for more details of 908.

At an operation 910, the irrigation water output determined at 908 can be used to control one or more sprinklers to irrigate the plant. For example, the irrigation output value can be sent to the controllers 104a-n from the server 106 via a cloud as shown in FIG. 1. Based on the irrigation output value, an individual controller, such as the controller 104a, can be configured to control a corresponding sprinkler. The individual controller can be configured to control one or more than one sprinkler. In one implementation, the individual controller is a console deployed at a site near the field(s) of interest. For instance, the individual controller, such as the controller 104a, is installed in a controller room next to the field(s) of interest to control the sprinklers. Please refer to FIG. 1 for more details of 910.

### Computer System for Implementing Various Embodiments

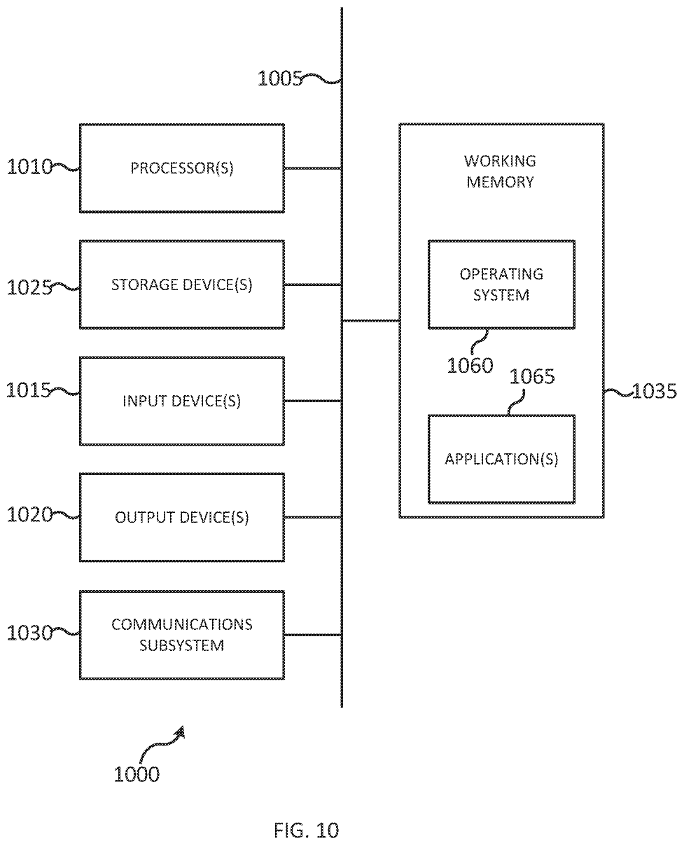

FIG. 10 illustrates a simplified computer system that can be used to implement various embodiments described and illustrated herein. A computer system 1000 as illustrated in FIG. 10 may be incorporated into devices such as a portable electronic device, mobile phone, or other device as described herein. FIG. 10 provides a schematic illustration of one embodiment of a computer system 1000 that can perform some or all of the steps of the methods provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1005, or may otherwise be in communication, as appropriate. The hardware elements may include one or more processors 1010, including without limitation one or more general-purpose processors and/or one or more special-purpose processors such as digital signal processing chips, graphics acceleration processors, and/or the like; one or more input devices 1015, which can include without limitation a mouse, a keyboard, a camera, and/or the like; and one or more output devices 1020, which can include without limitation a display device, a printer, and/or the like.

The computer system 1000 may further include and/or be in communication with one or more non-transitory storage devices 1025, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infrared communication device, a wireless communication device, and/or a chipset such as a Bluetooth™ device, an 1002.11 device, a WiFi device, a WiMax device, cellular communication facilities, etc., and/or the like. The communications subsystem 1030 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1030. In other embodiments, a portable electronic device, e.g. the first electronic device, may be incorporated into the computer system 1000, e.g., an electronic device as an input device 1015. In some embodiments, the computer system 1000 will further comprise a working memory 1035, which can include a RAM or ROM device, as described above.

The computer system 1000 also can include software elements, shown as being currently located within the working memory 1035, including an operating system 1060, device drivers, executable libraries, and/or other code, such as one or more application programs 10105, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 10, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1025 described above. In some cases, the storage medium might be incorporated within a computer system, such as computer system 1000. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1000 to perform methods in accordance with various embodiments of the technology. According to a set of embodiments, some or all of the procedures of such methods are performed by the computer system 1000 in response to processor 1010 executing one or more sequences of one or more instructions, which might be incorporated into the operating system 1060 and/or other code, such as an application program 10105, contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 1000, various computer-readable media might be involved in providing instructions/code to processor(s) 1010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1025. Volatile media include, without limitation, dynamic memory, such as the working memory 1035.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000.

The communications subsystem 1030 and/or components thereof generally will receive signals, and the bus 1005 then might carry the signals and/or the data, instructions, etc. carried by the signals to the working memory 1035, from which the processor(s) 1010 retrieves and executes the instructions. The instructions received by the working memory 1035 may optionally be stored on a non-transitory storage device 1025 either before or after execution by the processor(s) 1010.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. An intelligent irrigation system comprising one or more of a sprinkler and one or more processors configured to:
obtain imagery data regarding a plant;
determine a current life cycle stage of the plant based on the imagery data;
determine a plant crop coefficient for the plant based on the current life cycle stage of the plant;
determine irrigation water output for the plant based on the plant crop coefficient; and
control the sprinkler to irrigate the plant based on the irrigation water output determined for the plant.

2. The intelligent system of claim 1, wherein determining the current life cycle stage of the plant comprising:
determining at a plant parameter value including at least one of a type, a color, a height, or a size of the plant based on the imagery data regarding the plant; and
determining the current life cycle stage of the plant based on the plant parameter value.

3. The intelligent system of claim 2, wherein determining the current life cycle stage of the plant based on the plant parameter value comprises:
searching a database storing associations between different plant parameter values and corresponding different plants; and
determining the current life cycle stage of the plant based on the associations and the plant parameter value of the plant.

4. The intelligent system of claim 3, wherein the one or more processors are further configured to:
update the database based on at least one of a weather variable, user feedback information, or a geolocation variable.

5. The intelligent system of claim 1, wherein the determination of the irrigation water output for the plant based on the plant crop coefficient comprises:
determining a potential evapotranspiration value based on a weather variable; and
calculating the water output using the potential evapotranspiration value and plant crop irrigation coefficient for the plant.

6. The intelligent system of claim 1, wherein the imagery data includes a still image of the plant and/or a video of the plant.

7. The intelligent system of claim 1, wherein the determining the plant crop coefficient for the plant based on the current life cycle stage of the plant comprises:
determining one or more feature values for the plant based on the imagery data; and
determining the current life cycle stage of the plant based on the one or more feature values.

8. The intelligent system of claim 1, wherein the determining the plant crop coefficient for the plant based on the current life cycle stage of the plant further comprises: adjusting the current life cycle stage of the plant based on a geolocation of the plant, and/or user provided information regarding the plant.

9. The intelligent system of claim 1, wherein determining the irrigation water output for the plant based on the plant crop coefficient comprises: using the plant crop coefficient as a weight for determining the irrigation water output for the plant.

10. The intelligent system of claim 1, wherein determining the irrigation water output for the plant based on the plant crop coefficient comprises the following formula:
the irrigation water output for the plant=(a potential evapotranspiration value for the plant)×(the plant crop coefficient)

11. A method for controlling a system comprising one or more of a sprinkler, the method being implemented by a processor such that when the method is executed by the processor, the processor is caused to:
obtain imagery data regarding a plant;
determine a current life cycle stage of the plant based on the imagery data;
determine a plant crop coefficient for the plant based on the current life cycle stage of the plant;
determine irrigation water output for the plant based on the plant crop coefficient; and
control the sprinkler to irrigate the plant based on the irrigation water output determined for the plant.

12. The method of claim 11, wherein determining the current life cycle stage of the plant comprising:
determining at a plant parameter value including at least one of a type, a color, a height, or a size of the plant based on the imagery data regarding the plant; and
determining the current life cycle stage of the plant based on the plant parameter value.

13. The method of claim 12, wherein determining the current life cycle stage of the plant based on the plant parameter value comprises:
searching a database storing associations between different plant parameter values and corresponding different plants; and
determining the current life cycle stage of the plant based on the associations and the plant parameter value of the plant.

14. The method of claim 13, wherein the processors is further caused to:
update the database based on at least one of a weather variable, user feedback information, or a geolocation variable.

15. The method of claim 11, wherein the determination of the irrigation water output for the plant based on the plant crop coefficient comprises:
determining a potential evapotranspiration value based on a weather variable; and
calculating the water output using the potential evapotranspiration value and plant crop irrigation coefficient for the plant.

16. The method of claim 11, wherein the imagery data includes a still image of the plant and/or a video of the plant.

17. The method of claim 11, wherein the determining the plant crop coefficient for the plant based on the current life cycle stage of the plant comprises:
determining one or more feature values for the plant based on the imagery data; and
determining the current life cycle stage of the plant based on the one or more feature values.

18. The method of claim 11, wherein the determining the plant crop coefficient for the plant based on the current life cycle stage of the plant further comprises: adjusting the current life cycle stage of the plant based on a geolocation of the plant, and/or user provided information regarding the plant.

19. The method of claim 11, wherein determining the irrigation water output for the plant based on the plant crop coefficient comprises: using the plant crop coefficient as a weight for determining the irrigation water output for the plant.

20. The method of claim 11, wherein determining the irrigation water output for the plant based on the plant crop coefficient comprises the following formula:
the irrigation water output for the plant=(a potential evapotranspiration value for the plant)×(the plant crop coefficient)
